(19) United States
(12) Patent Application Publication
(10) Pub. No.: US 2018/0362048 A1
(43) Pub. Date: Dec. 20, 2018

(54) DETECTION DEVICE, ROAD SURFACE INFORMATION SYSTEM, AND VEHICLE

(71) Applicant: Murata Manufacturing Co., Ltd., Kyoto (JP)

(72) Inventor: Masaru JUNO, Kyoto (JP)

(21) Appl. No.: 16/111,887

(22) Filed: Aug. 24, 2018

Related U.S. Application Data
(63) Continuation of application No. PCT/JP2017/005856, filed on Feb. 17, 2017.

(30) Foreign Application Priority Data
Feb. 25, 2016 (JP) 2016-034655

(51) Int. Cl. B60W 40/06; B60W 40/11; B60R 11/04; G05D 1/00

(52) U.S. Cl. CPC B60W 40/06; B60W 40/11; G05D 2201/0213; G05D 1/0094; B60W 2420/42; B60R 11/04

(57) ABSTRACT

A detection device is a detection device mounted on a moving object that moves on a road surface. The detection device includes a detection unit, an image detector, and a controller. The detection unit detects a shock on the moving object. The image detector captures an image of the road surface behind in a direction in which the moving object moves. The controller controls an operation of the image detector. On the basis of a detection result obtained by the detection unit, the controller causes the image detector to capture an image of the road surface on which the vehicle has passed when a shock on the vehicle has been detected.

This is a continuation of International Application No. PCT/JP2017/005856 filed on Feb. 17, 2017 which claims priority from Japanese Patent Application No. 2016-034655 filed on Feb. 25, 2016. The contents of these applications are incorporated herein by reference in their entireties.

### BACKGROUND

### Technical Field

The present disclosure relates to a detection device that detects defects on the road surface, and a road surface information system and a vehicle that are provided with the detection device.

Defects such as sagging, cracks, and unevenness may occur on the road surface due to aging. There have been needs for constantly maintaining and managing the road surface so as to promptly cope with such defects on the road surface by repairing the road surface or warning people of the defects. However, a very high cost is necessary to maintain and manage the nationwide road infrastructure, and it is therefore difficult to take prompt actions.

Two methods are mainly known as conventional road inspection technologies. The first method is a method using a sophisticated inspection vehicle for measuring unevenness of the road surface by using an optical system or laser. The second method is a method for estimating abnormal portions of the road by conducting computer analysis to monitor the vibrations of a driving car and to detect the singularity of the vibrations (for example, see Patent Document 1).

Patent Document 1 discloses a road surface evaluating method for monitoring the pitching angular velocity of a vehicle, obtained by an angular velocity sensor, in synchronizing with GPS information obtained by GPS. The road surface evaluating method of Patent Document 1 performs data analysis using a transfer function from the angular velocity response of the vehicle being measured to the acceleration response of a quarter car (hereinafter referred to as “QC”), which is a virtual vehicle serving as a reference, and a correlation function of the acceleration response of the QC and the international roughness index (IRI). In Patent Document 1, the acceleration response of the QC is estimated using the obtained pitching angular velocity of the vehicle and the above-mentioned transfer function, and the international roughness index (IRI) is estimated using the estimated acceleration response of the QC and the above-mentioned correlation function.

Patent Document 1: Japanese Unexamined Patent Application Publication No. 2015-28456

### BRIEF SUMMARY

Of the conventional road surface inspection methods, according to the above-mentioned first method, defects (abnormality) on the road surface can be accurately and quantitatively measured using a sophisticated inspection vehicle. However, a sophisticated inspection vehicle is expensive, and it also takes time to perform data analysis. According to the above-mentioned second method, abnormal portions of the road are indirectly estimated from the vibrations of a vehicle by performing calculations based on a special algorithm. In this case, an advanced processor is necessary for performing calculations based on a special algorithm, which involves the processing load and data amount in data analysis.

The present disclosure provides, in a road surface information system that accumulates road surface information indicating defects on the road surface, a detection device capable of efficiently collecting road surface information, and the road surface information system.

A detection device according to an aspect of the present disclosure is a detection device mounted on a mobile object that moves on a road surface. The detection device includes a detection unit, an image detector, and a controller. The detection unit detects a shock on the moving object. The image detector captures an image of the road surface behind in a direction in which the moving object moves. The controller controls an operation of the image detector. On the basis of a detection result obtained by the detection unit, the controller causes the image detector to capture an image of the road surface on which the vehicle has passed when a shock on the vehicle has been detected.

A road surface information system according to an aspect of the present embodiment includes a detection device and a server device. The server device manages image data captured by an image detector of the detection device and position information indicating a position at which the image data is captured in association with each other.

### Advantageous Effects of Disclosure

A detection device and a road surface information system according to an aspect of the present disclosure captures, with the use of an image detector, an image of a road surface on which a moving object which is moving on the road surface has passed when a shock on the moving object has been detected. Accordingly, in a road surface information system that accumulates road surface information, a detection device capable of efficiently collecting road surface information, and the road surface information system can be provided.

### BRIEF DESCRIPTION OF DRAWINGS

FIG. 1 is a diagram illustrating the configuration of a road surface information system according to a first embodiment.

FIG. 2 is a block diagram illustrating the configuration of a smart camera according to the first embodiment.

FIG. 3 is a block diagram illustrating the configuration of a mobile terminal according to the first embodiment.

FIG. 4 is a block diagram illustrating the configuration of a server device in the road surface information system.

FIG. 5 is an explanatory diagram of a road surface information DB in the road surface information system.

FIG. 6 is a diagram illustrating a display example of road surface information in the road surface information system.

FIG. 7 is a sequence diagram illustrating the operation of the road surface information system according to the first embodiment.

FIGS. 8A and 8B include explanatory diagrams of the operation of the smart camera according to the first embodiment.

FIG. 9 is a diagram illustrating a display example of an image captured by the smart camera.

FIG. 10 is a diagram illustrating the configuration of a road surface information system according to a second embodiment.

FIG. 11 is a block diagram illustrating the configuration of a smart camera according to the second embodiment.

FIG. 12 is a flowchart illustrating the operation of the smart camera according to the second embodiment.

FIG. 13 is a diagram illustrating the configuration of a road surface information system according to a third embodiment.

### DESCRIPTION OF EMBODIMENTS

Hereinafter, a detection device, a vehicle, and a road surface information system according to the present disclosure will be described with reference to the accompanying drawings.

Embodiments are exemplary and, needless to say, a partial replacement or combination of configurations discussed in different embodiments is possible. From a second embodiment onward, descriptions of points that are common to those of a first embodiment will be omitted, and only different points will be described. In particular, the same (or similar) advantageous effects achieved by the same (or similar) configuration will not be repeatedly mentioned in later embodiments.

### First Embodiment

### 1. Configuration

### 1-1. Overview

The overview of a road surface information system according to the first embodiment will be described.

The road surface information system according to the present embodiment is a system that collects, for a cloud server managed by a service provider for autonomous driving or M2M, road surface information indicating defects (abnormality of the road surface) such as unevenness including depressions, cracks, ruts, and the like of the road surface. On the basis of the road surface information collected by this system, the cloud server notifies, for example, a road maintenance company of abnormal portions where there are defects on the road surface or warns vehicles approaching the abnormal portions.

In the road surface information system according to the present embodiment, for example, users are recruited by a point charge system or the like to collect road surface information from a wide range of general vehicles, and the collected road surface information is uploaded to the cloud server as needed. Accordingly, the coverage of information gathering for a vast amount of nationwide road infrastructure can be expanded, and road surface information can be efficiently collected. Hereinafter, the configuration of this system will be described.

### 1-2. System Configuration

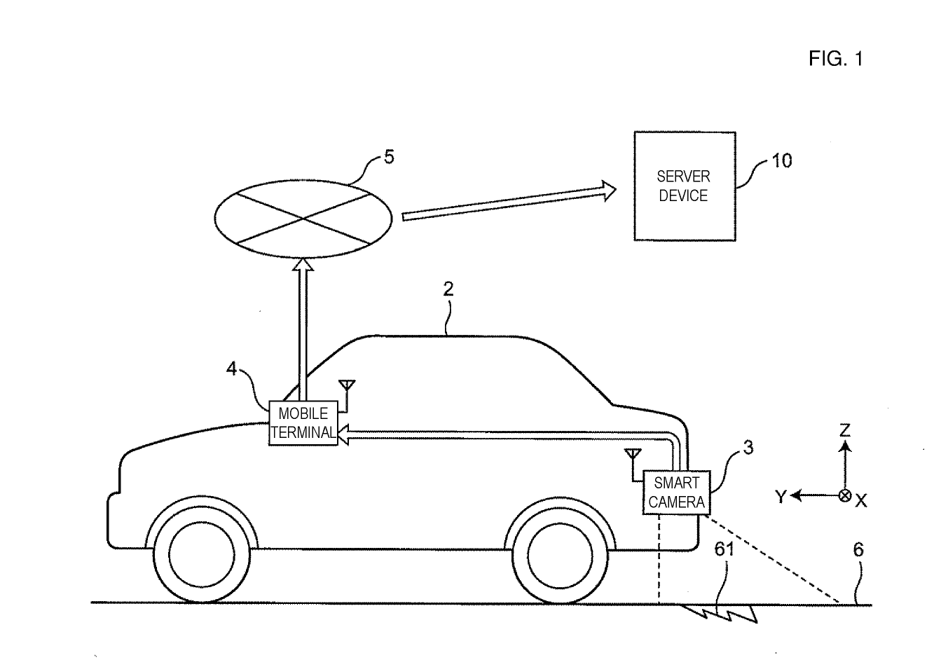

FIG. 1 is a diagram illustrating the configuration of the road surface information system according to the first embodiment. Hereinafter, as illustrated in FIG. 1, it is assumed that the direction in which a vehicle 2 progresses is the Y direction, the height direction of the vehicle 2 is the Z direction, and the width direction of the vehicle 2 that is orthogonal to the Y direction and the Z direction is the X direction.

The road surface information system according to the present embodiment includes a server device 10, a smart camera 3 mounted on the vehicle 2, and a mobile terminal 4, as illustrated in FIG. 1. The vehicle 2 is, for example, a passenger car, and is an example of a moving object in the road surface information system according to the present embodiment.

The smart camera 3 is an image capturing device attached to the vehicle 2 in order to detect unevenness (pot holes) 61 of a road surface 6 from the vehicle 2 and to obtain a captured image. The smart camera 3 transmits, for example, image data indicating a captured image of the unevenness 61 of the road surface 6 to the mobile terminal 4. The smart camera 3 is an example of a detection device that detects the unevenness 61 of the road surface 6 in the present embodiment.

The smart camera 3 is attached to, for example, the rear bumper or the rear gate of the vehicle 2 so as to be able to capture an image of the road surface 6 behind the vehicle in the direction Y in which the vehicle 2 progresses. The smart camera 3 may have a function as a rear camera for allowing the driver to check the field of view behind the vehicle 2 or may be a device dedicated to this system. Using the smart camera 3 functioning as a rear camera makes it easier for general users to use this system. The configuration of the smart camera 3 will be described in detail later.

The mobile terminal 4 is, for example, an information terminal owned by the driver of the vehicle 2. The mobile terminal 4 is, for example, a smartphone, a tablet terminal, or a cellular phone.

The mobile terminal 4 communicates information with the smart camera 3 in the vehicle 2, and communicates with and connects to the server device 10 via a network 5 such as the Internet. The mobile terminal 4 is an example of an information device that realizes the function of a gateway between the smart camera 3 and the server device 10 in this system. The configuration of the mobile terminal 4 will be described in detail later.

The server device 10 is an information processing device that is accessed as appropriate in cloud computing of a cloud server, for example. The server device 10 analyzes and manages road surface information collected in this system as, for example, big data. In the cloud server, parallel processing may be performed as appropriate using many server devices 10. Note that the server device 10 may be a PC (personal computer). The configuration of the server device 10 will be described in detail later.

### 1-2-1. Configuration of Smart Camera

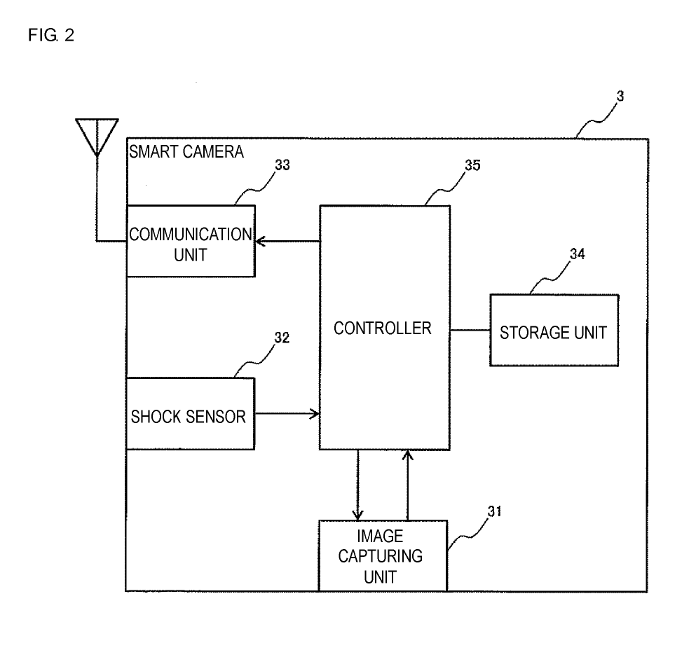

The configuration of the smart camera 3 will be described in detail with reference to FIG. 2. FIG. 2 is a block diagram illustrating the configuration of the smart camera 3 according to the present embodiment.

The smart camera 3 includes an image detector 31, a shock sensor 32, a communication unit 33 (e.g., a transmitter, receiver, or transceiver), a storage unit 34 (e.g., memory), and a controller 35 (e.g., an integrated circuit processor), as illustrated in FIG. 2.

The image detector 31 includes image capturing elements, such as CCD image sensors or CMOS image sensors, and a wide-angle lens whose angle of view is, for example, 100 degrees or greater. Alternatively, the image detector 31 may include a fisheye camera (omni-directional camera) provided with a fisheye lens. Accordingly, an image capturing range with a wide angle of view can be secured, and incomplete image capturing of the unevenness 61 of the road surface 6 can be reduced.

The shock sensor 32 includes, for example, a piezoelectric acceleration sensor (accelerometer) provided with a piezoelectric element. The shock sensor 32 generates a sensor signal based on charge generated by the piezoelectric element in accordance with acceleration in a certain direction (such as the Z direction in FIG. 1), and detects a shock in the certain direction on the basis of variations of the signal level of the sensor signal. The signal level of the sensor signal varies in accordance with a shock applied to and vibration of the smart camera 3. The generated sensor signal is input to the controller 35.

In the present embodiment, a shock to be detected by the shock sensor 32 is a sudden change in force such as normal force transferred from the road surface 6 to the vehicle 2. In the present embodiment, a shock is detected on the basis of a change in acceleration in the Z direction of the vehicle 2 from the gravitational acceleration by a certain value or greater. The shock sensor 32 may be configured to detect acceleration not only in one certain direction, but also in two-axis or three-axis directions. The shock sensor 32 is an example of a detection unit that detects a shock on the smart camera 3 according to the present embodiment.

The communication unit 33 is a communication module that performs wireless communication in accordance with a communication standard of, for example, Bluetooth (registered trademark). The communication unit 33 performs communication and connection between the smart camera 3 and the mobile terminal 4, and transmits, for example, image data of an image captured by the image detector 31 to the mobile terminal 4. The communication unit 33 may use the communication method based on not only Bluetooth (registered trademark), but also Wi-Fi or NFC (near-field communication).

The storage unit 34 is a storage medium that stores programs and data necessary for realizing the functions of the smart camera 3 and includes, for example, flash memory. The storage unit 34 records, for example, image data of a captured image.

The controller 35 includes a CPU that realizes a certain function in cooperation with software, for example. The controller 35 controls the overall operation of the smart camera 3. The controller 35 realizes various functions by reading data and programs stored in the storage unit 34 and performing various arithmetic processing operations.

For example, the controller 35 outputs a trigger signal indicating the start timing of an image capturing operation and controls the image capturing operation of the image detector 31. In addition, the controller 35 compares, for example, the signal level of a sensor signal from the shock sensor 32 with a certain threshold, and analyzes the signal waveform of the sensor signal. The controller 35 determines whether or not the shock sensor 32 has detected a shock caused by the unevenness 61 of the road surface 6, on the basis of the state, such as the signal level and the signal waveform, of the sensor signal.

The controller 35 may be a hardware circuit such as a dedicated electronic circuit designed to realize a certain function or a reconfigurable electronic circuit. The controller 35 may include various semiconductor integrated circuits such as CPU, MPU, microcomputer, DSP, FPGA, and ASIC.

### 1-2-2. Configuration of Mobile Terminal

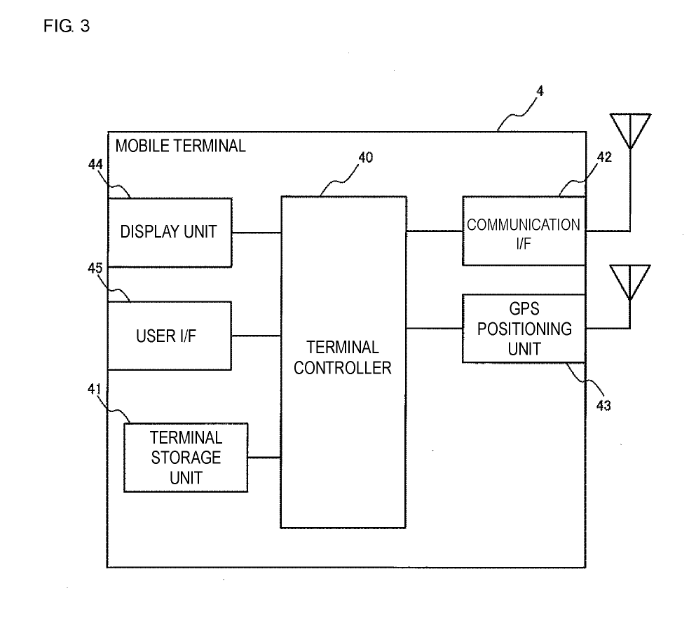

The configuration of the mobile terminal 4 will be described in detail with reference to FIG. 3. FIG. 3 is a block diagram illustrating the configuration of the mobile terminal 4 according to the present embodiment.

The mobile terminal 4 includes a terminal controller 40 (e.g., an integrated circuit processor), a terminal storage unit (e.g., memory), a communication interface 42 (e.g., a transmitter, receiver, or transceiver), a GPS positioning unit 43 (or similar positioning system), a display unit 44 (e.g., a display screen), and a user interface 45 (hereinafter “interface” will be abbreviated as “I/F”), as illustrated in FIG. 3.

The terminal controller 40 includes a CPU that realizes a certain function in cooperation with software, for example. The terminal controller 40 controls the overall operation of the mobile terminal 4. The terminal controller 40 realizes various functions by reading data and programs stored in the terminal storage unit 41 and performing various arithmetic processing operations. The terminal controller 40 may be a hardware circuit such as a dedicated electronic circuit designed to realize a certain function or a reconfigurable electronic circuit. The terminal controller 40 may include various semiconductor integrated circuits such as CPU, MPU, microcomputer, DSP, FPGA, and ASIC.

The terminal storage unit 41 is a storage medium that stores programs and data necessary for realizing the functions of the mobile terminal 4 and includes, for example, flash memory. In addition, the terminal storage unit 41 may include a semiconductor device such as DRAM and SRAM, which may temporarily store data or function as a work area for the terminal controller 40. The terminal storage unit 41 stores, for example, image data received from the smart camera 3 via the communication I/F 42.

The communication I/F 42 is a communication module that supports short-range wireless communication such as Bluetooth (registered trademark) and network communication in conformity with a certain communication standard. The certain communication standard includes a communication standard such as IEEE 802.3, IEEE 802.11a/11b/11g/11ac, and the like. The communication I/F 42 performs wireless communication with the smart camera 3 by performing short-range wireless communication. In addition, the communication I/F 42 connects to the network 5 and performs data communication with the server device 1.

The GPS positioning unit 43 is a module that receives electromagnetic waves (GPS information) from a GPS satellite, and performs positioning the latitude, longitude, and altitude of a point at which the electromagnetic waves are received. The GPS positioning unit 43 is an example of a position information obtaining unit that obtains position information indicating the position of the vehicle 2, such as the latitude measured.

The display unit 44 includes, for example, a liquid crystal display or an organic EL display. The display unit 44 displays various types of information such as information input from the user I/F 45.

The user I/F 45 is an operation member for the user of the mobile terminal 4 to perform operations. The user I/F 45 includes, for example, a touchscreen, a touch pad, a keyboard, a button, a switch, and a combination thereof. The user I/F 45 is an example of an obtaining unit that obtains various information input from the user.

### 1-2-3. Configuration of Server Device

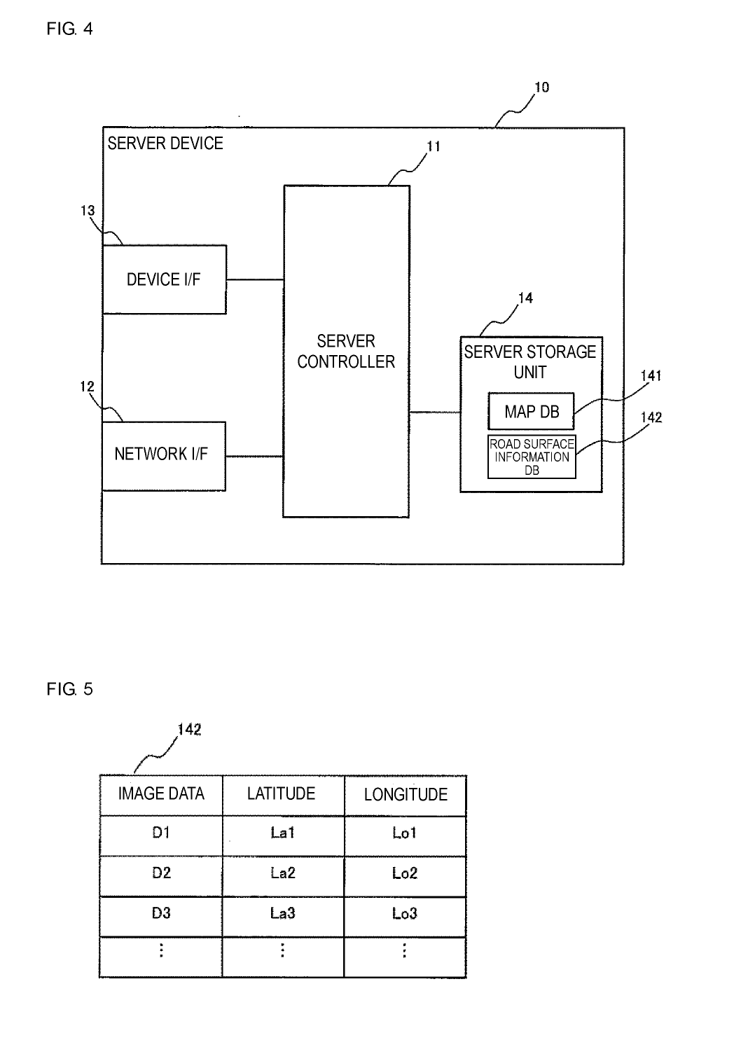

The configuration of the server device 10 will be described in detail with reference to FIG. 4. FIG. 4 is a block diagram illustrating the configuration of the server device 10 in the road surface information system according to the present

The server device 10 includes a server controller 11 (e.g., an integrated circuit processor), a network I/F 12 (e.g., a transmitter, receiver, or transceiver), a device I/F 13, and a server storage unit 14 (e.g., memory), as illustrated in FIG. 4.

The server controller 11 includes a CPU that realizes a certain function in cooperation with software, for example. The server controller 11 controls the overall operation of the server device 10. The server controller 11 realizes various functions by reading data and programs stored in the server storage unit 14 and performing various arithmetic processing operations. For example, the server controller 11 performs data analysis and image analysis based on machine learning or the like on collected data. The server controller 11 may be a hardware circuit such as a dedicated electronic circuit designed to realize a certain function or a reconfigurable electronic circuit. The server controller 11 may include various semiconductor integrated circuits such as CPU, MPU, microcomputer, DSP, FPGA, and ASIC.

The network I/F 12 is a circuit (module) for connecting the server device 10 to the network 5 via a wireless or wired communication line. The network I/F 12 performs communication in conformity with a certain communication standard. The certain communication standard includes a communication standard such as IEEE 802.3, IEEE 802.11a/11b/11g/11ac, and the like.

The device I/F 13 is a circuit (module) for connecting the server device 10 to another device. The device I/F 13 performs communication in accordance with a certain communication standard. The certain standard includes USB, HDMI (registered trademark), IEEE 1395, Wi-Fi, Bluetooth (registered trademark), and the like.

The server storage unit 14 is a storage medium that stores programs and data necessary for realizing the functions of the server device 10, and includes, for example, a hard disk (HDD) and a semiconductor storage device (SSD). In addition, the server storage unit 14 may include a semiconductor device such as DRAM and SRAM, which may temporarily store data or function as a work area for the server controller 11. Note that the server storage unit 14 may be configured as a storage device separate from the server device 10.

### 1-2-3-1. About Databases

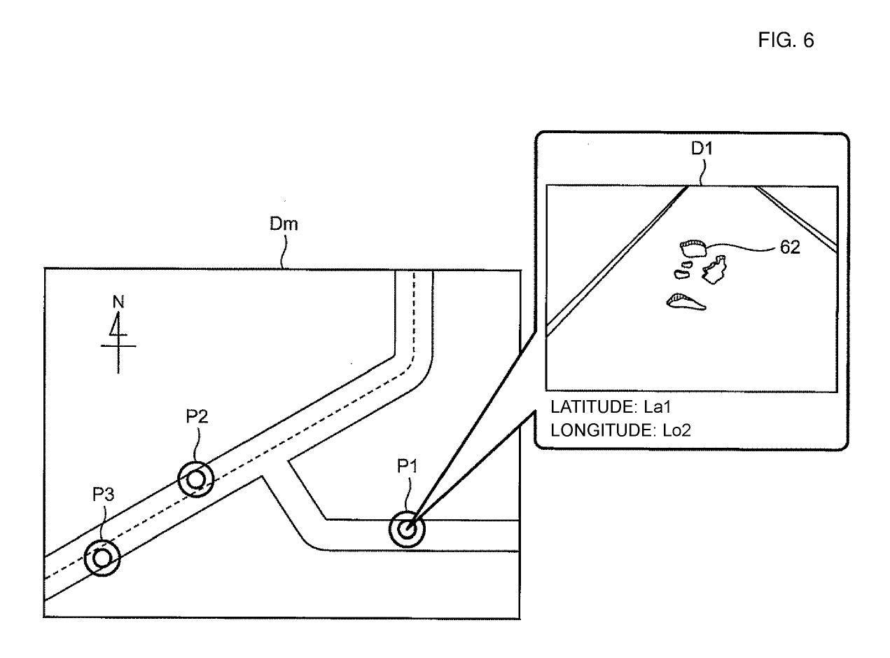

In this system, various types of databases (hereinafter “database” will be abbreviated as “DB”) stored in the server storage unit 14 are used. Hereinafter, various DBs stored in the server storage unit 14 will be described with reference to FIGS. 5 and 6. FIG. 5 is an explanatory diagram of a road surface information DB in the road surface information system. FIG. 6 is a diagram illustrating a display example of road surface information in the road surface information system.

The server storage unit 14 stores, for example, a map DB 141 and a road surface information DB 142. The map DB 141 is a database for managing map data indicating maps related to various areas (see FIG. 6). The road surface information DB 142 is a database for managing road surface information such as the state and position of defects on the road surface.

The road surface information DB 142 manages “latitude” and “longitude” in association with “image data”, as illustrated in FIG. 5. In the road surface information DB 142 in FIG. 5, D1, D2, and D3 represent items of image data of captured images of defects on the road surface. In the road surface information DB 142 in FIG. 5, latitude Lal and longitude Lo1, latitude La2 and longitude Lo2, and latitude La3 and longitude Lo3, which constitute items of position information, are associated with the items of image data D1, D2, and D3, respectively. In the road surface information DB 142, the items of image data D1, D2, and D3 and the items of position information associated therewith constitute items of road surface information. The items of image data D1, D2, and D3 may be captured by one smart camera 3, or may be separately captured by a plurality of smart cameras 3.

As illustrated in FIG. 6, the server device 10 has a function of mapping and displaying road surface information managed in the road surface information DB 142 on map data Dm managed in the map DB 141 on the basis of the map DB 141 and the road surface information DB 142. Road surface information can be displayed, for example, on an external display device via the device I/F 13 or may be displayed on an external browsing terminal via the network I/F 12.

As illustrated in FIG. 6, the map data Dm includes detailed information such as lanes of the road. Icons P1, P2, and P3 are icons based on the items of position information associated with the items of image data Dl, D2, and D3, respectively, in the road surface information DB 142. The server controller 11 reads data from the road surface information DB 142, and, on the basis of, for example, position information with which the image data D1 is associated in the road surface information DB 142, displays (plots) the icon P1 at the position with the latitude La1 and the longitude Lol on the map data Dm. In addition, for example, the image data D1 is displayed when the icon P1 is selected by a user operation. Those who are involved in road maintenance projects, such as road inspection companies, can accurately recognize abnormal portions of the road from the icons P1, P2, and P3 on the map by checking the road surface information such as that illustrated in FIG. 6 with the use of a browsing terminal or the like, and can execute the projects.

### 2. Operation

### 2-1. Overview of Operation

The overview of the operation of the road surface information system according to the present embodiment will be described. In this system, the smart camera 3 (FIG. 1) is assumed to be mounted on the widely common vehicle 2 such as a passenger car owned by a common person. In the vehicle 2, the mobile terminal 4 gives position information to the items of image data D1, D2, and D3 captured by the smart camera 3, and uploads the image data D1, D2, and D3 with the position information as items of road surface information to the server device 10 via the network 5 (FIG. 5). The server device 10 accumulates the road surface information from the mobile terminal 4 in the road surface information DB 142 in the server storage unit 14. According to this system, road surface information can be collected as needed from the widely common vehicle 2, thereby efficiently widening the coverage of information gathering.

Because the image data D2 obtained by directly capturing an image of the unevenness 62 of the road surface is accumulated in the road surface information DB 142 in this system, as illustrated in FIG. 6, the user of this system can accurately grasp the state of defects on the road surface from the visual information. However, to capture an image of defects on the road surface, for example, if the road is monitored all the time while the vehicle 2 is driving, this system is overloaded with the processing load even when no defect on the road surface is present in the image data, and this is inefficient in terms of the data mount and the processing load.

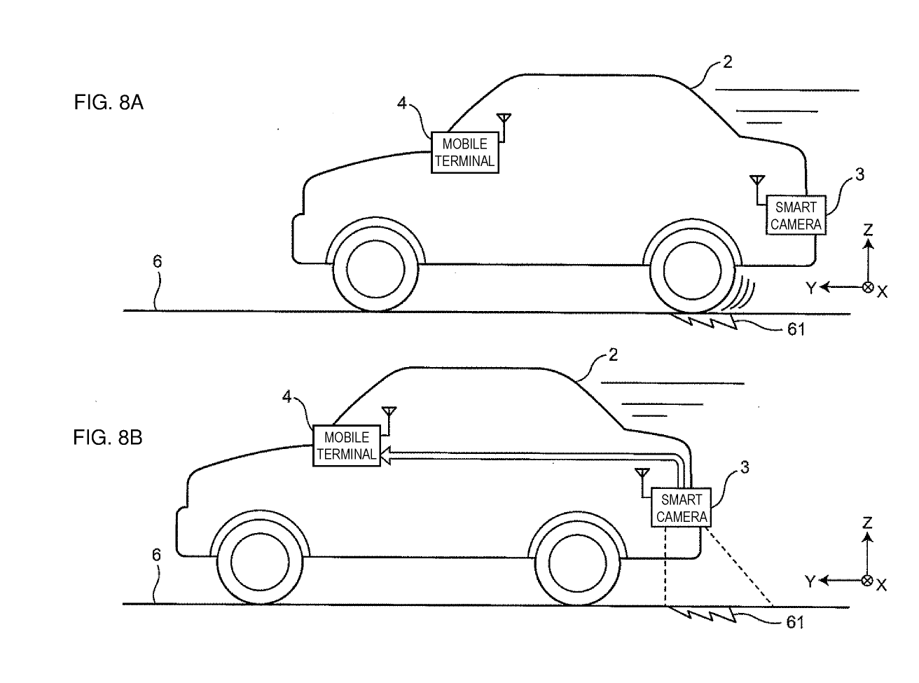

Therefore, in the present embodiment, using the shock sensor 32, the smart camera 3 detects the unevenness 61 of the road surface 6 on which the vehicle 2 is driving (see FIG. 8A), and captures an image of the unevenness 61 after the vehicle 2 passes the unevenness 61 (see FIG. 8B). Accordingly, image data showing defects (unevenness 61) on the road surface 6 can be efficiently obtained with the smart camera 3.

### 2-2. Details of Operation

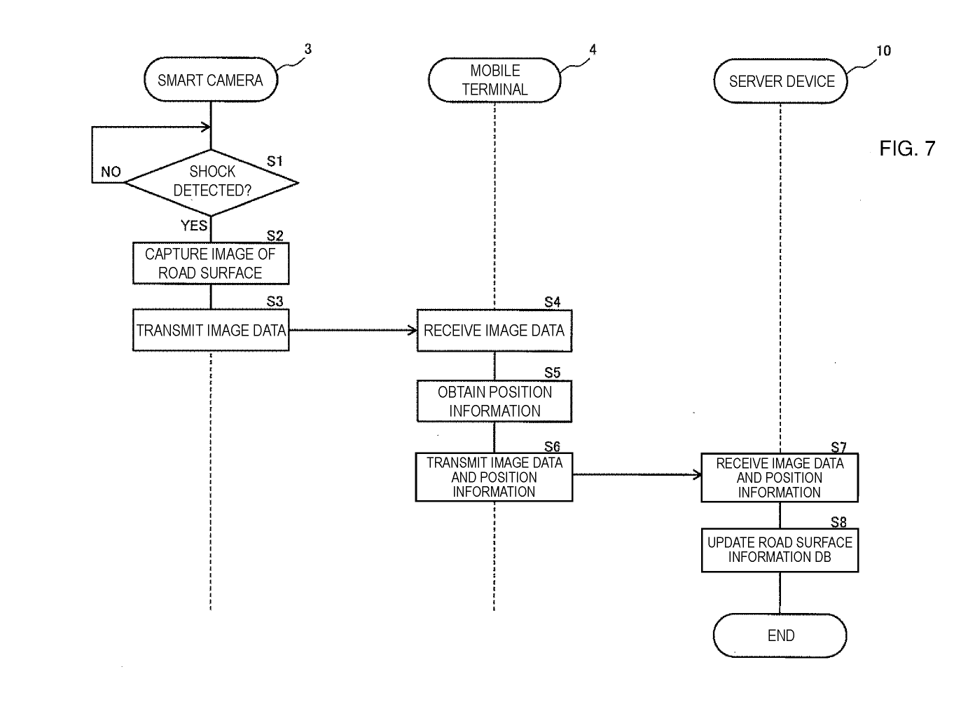

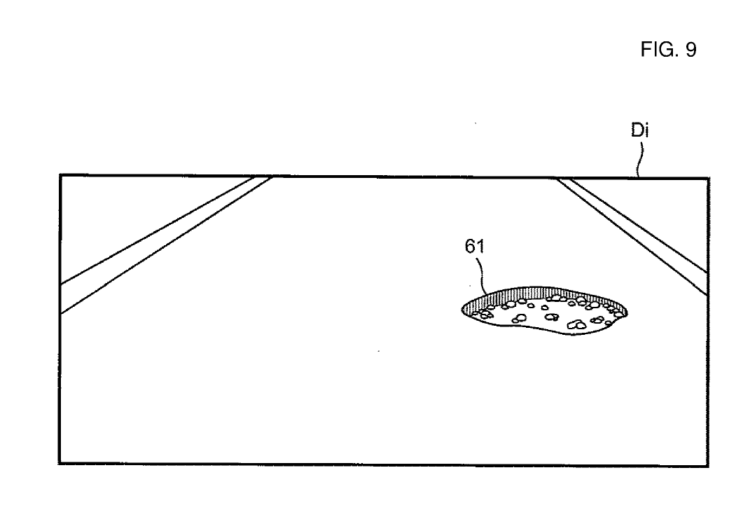

The detailed operation of the road surface information system and the smart camera 3 according to the present embodiment will be described with reference to FIGS. 7 to 9. FIG. 7 is a sequence diagram illustrating the operation of the road surface information system according to the first embodiment. FIGS. 8A and 8B include explanatory diagrams of the operation of the smart camera 3. FIG. 9 is a diagram illustrating a display example of an image captured by the smart camera 3.

The sequence in FIG. 7 starts when, for example, the mobile terminal 4 and the smart camera 3 establish a communication connection.

In FIG. 7, at first, the controller 35 of the smart camera 3 (FIG. 2) determines, on the basis of a sensor signal from the shock sensor 32, whether or not the shock sensor 32 has detected a shock (S1). For example, the controller 35 determines whether or not the signal level of the sensor signal has exceeded a certain threshold. The certain threshold is a threshold indicating a reference for shock caused by the unevenness of the road surface.

When the controller 35 determines that the shock sensor 32 has detected no shock (NO in S1), the controller 35 repeats the processing in step S1 at a certain cycle (such as 1/30 seconds).

In contrast, when the controller 35 determines that the shock sensor 32 has detected a shock (YES in S1), the controller 35 outputs a trigger signal to the image detector 31 to cause the image detector 31 to capture an image of the road surface 6 (S2). In the processing in step S2, the image detector 31 may capture an image of one frame at a time point indicated by the trigger signal from the controller 35, or may capture images of multiple frames at a certain frame rate (such as 30 fps) consecutively for a certain period (such as 1 second) from a time point indicated by the trigger signal. Alternatively, the image detector 31 may capture image data of a certain number of frames from the trigger signal.

As illustrated in FIG. 8A, when the vehicle 2 passes the unevenness 61 of the road surface 6, normal force from the road surface 6 changes, and a shock (a sudden change in acceleration in the Z direction) occurs on the vehicle 2 due to the vehicle's 2 passing the unevenness 61 of the road surface 6. In response to this, the smart camera 3 detects the shock based on the unevenness 61 on the basis of a sensor signal from the shock sensor 32 (YES in S1), and, as illustrated in FIG. 8B, captures an image of the road surface 6 after the vehicle 2 passes the unevenness 61 of the road surface 6 (S2). Accordingly, as illustrated in FIG. 9, image data Di of a captured image showing the unevenness 61 of the road surface 6 can be obtained.

Referring back to FIG. 7, next, the controller 35 transmits the image data Di, captured by the image detector 31, to the mobile terminal 4 via the communication unit 33 (S3).

In the mobile terminal 4, the terminal controller 40 (FIG. 3) receives the image data Di from the smart camera 3 via the communication I/F 42 (S4). The received image data Di is temporarily stored in the terminal storage unit 41.

On receipt of the image data Di from the smart camera 3 (S4), the terminal controller 40 obtains position information indicating the position of the mobile terminal 4, that is, the current position of the vehicle 2, from the GPS positioning unit 43 (S5).

Next, the terminal controller 40 transmits road surface information including the image data Di, received from the smart camera 3, and the position information, obtained from the GPS positioning unit 43, to the server device 10 via the communication I/F 42 and the network 5 (FIG. 1) (S6).

In the server device 10, the server controller 11 (FIG. 4) receives the road surface information including the image data Di and the position information from the mobile terminal 4 via the network I/F 12 (S7).

Next, the server controller 11 stores the road surface information, received from the mobile terminal 4, in the road surface information DB 142 in the server storage unit 14, thereby updating the road surface information DB 142 (S8), and the process ends.

According to the above process, an image of the unevenness 61 of the road surface 6 is captured in response to detection of a shock caused by the unevenness 61 while the vehicle 2 is driving. Accordingly, compared with the case of capturing an image of the state of the road surface at all times, road surface information indicating defects on the road surface can be efficiently collected.

In addition, the mobile terminal 4 may perform image analysis on the image data Dl from the smart camera 3. For example, the terminal controller 40 may receive image data of multiple frames from the smart camera 3 (S4), select a frame that more clearly shows the unevenness 61 of the road surface 6 by performing image analysis, and transmit the image data D1 of the selected frame to the server device 10 (S6). In addition, the terminal controller 40 may extract information on lanes or the like in the image data by performing image analysis, and obtain information indicating the detailed position of the unevenness 61 of the road surface 6.

In addition, the above-described image analysis may be performed not only by the mobile terminal 4, but also by the server device 10 or by the smart camera 3 instead of the mobile terminal 4.

### 3. Conclusion

As has been described above, the smart camera 3 according to the present embodiment is a detection device mounted on the vehicle 2 moving on the road surface 6. The smart camera 3 includes the shock sensor 32, the image detector 31, and the controller 35. The shock sensor 32 detects a shock on the vehicle 2. The image detector 31 captures an image of the road surface behind in the direction Y in which the vehicle 2 moves. The controller 35 controls the operation of the image detector 31. On the basis of a detection result obtained by the shock sensor 32, the controller 35 causes the image detector 31 to capture an image of the road surface on which the vehicle 2 has passed when a shock on the vehicle 2 has been detected.

According to the above smart camera 3, the image detector 31 captures an image of the road surface on which the vehicle 2 has passed when a shock generated by the vehicle's 2 passing defects such as the unevenness 61 of the road surface 6 has been detected. Accordingly, in a road surface information system that accumulates road surface information, a detection device capable of efficiently collecting road surface information can be provided.

In the present embodiment, the smart camera 3 further includes the communication unit 33, which transmits image data Di captured by the image detector 31, to an external device such as the mobile terminal 4. With the communication unit 33, the captured image data Di can be collected outside the smart camera 3. Note that the smart camera 3 may not include the communication unit 33, and, for example, the image data Di may be accumulated in the storage unit 34 or may be stored in an external storage medium.

In the present embodiment, the image detector 31 of the smart camera 3 may include a fisheye camera. Accordingly, an image capturing range with a wide angle of view can be secured, and incomplete image capturing of the unevenness 61 of the road surface 6 can be reduced.

The road surface information system according to the present embodiment may include the smart camera 3 and the server device 10. The server device 10 manages image data Di captured by the image detector 31 of the smart camera 3 and position information indicating a position at which the image data Di is captured in association with each other (see FIG. 5). Accordingly, road surface information can be efficiently obtained from the smart camera 3.

In the present embodiment, the road surface information system further includes the mobile terminal 4, which obtains from the smart camera 3 image data Di captured by the image detector 31. The mobile terminal 4 transmits the image data Di, along with position information indicating a position at which the image data Di is captured, to the server device 10. An information device that communicates information between the smart camera 3 and the server device 10 is not limited to the mobile terminal 4, and, for example, may be a car navigation apparatus.

### Second Embodiment

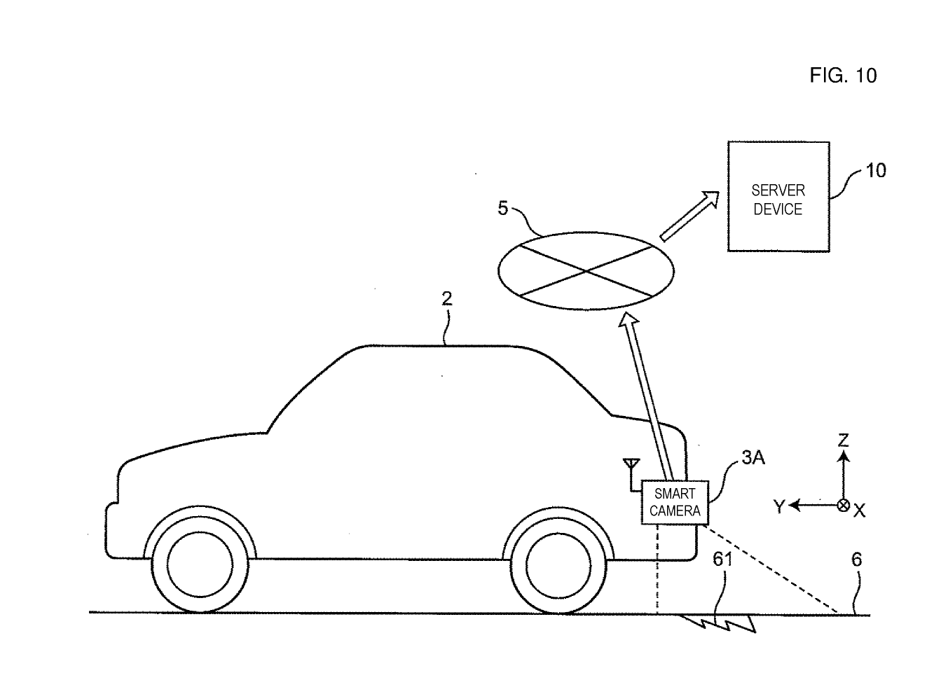

In the first embodiment, the mobile terminal 4 is used for uploading road surface information to the server device 10. In a second embodiment, a road surface information system configured without necessarily using the mobile terminal 4 will be described. Hereinafter, the present embodiment will be described with reference to FIGS. 10 to 12.

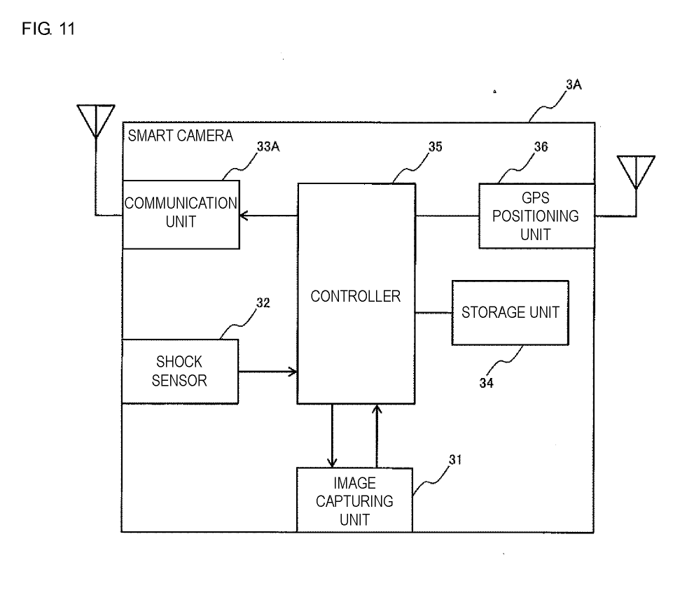

FIG. 10 is a diagram illustrating the configuration of the road surface information system according to the second embodiment. FIG. 11 is a block diagram illustrating the configuration of a smart camera 3A according to the second embodiment.

As illustrated in FIG. 10, the road surface information system according to the present embodiment includes the smart camera 3A and the server device 10. The smart camera 3A directly connects to the network 5 without necessarily using an information device such as a mobile terminal, and performs data communications with the server device 10. As illustrated in FIG. 11, the smart camera 3A includes a communication unit 33A, which performs data communication using a network such as the Internet, instead of the communication unit 33 in the first embodiment (see FIG. 2).

In addition, as illustrated in FIG. 11, the smart camera 3A further includes a GPS positioning unit 36, in addition to the same (or similar) configuration as that of the smart camera 3 according to the first embodiment (see FIG. 2). The GPS positioning unit 36 includes, for example, the same (or similar) module as that of the GPS positioning unit 43 of the mobile terminal 4 according to the first embodiment (see FIG. 3).

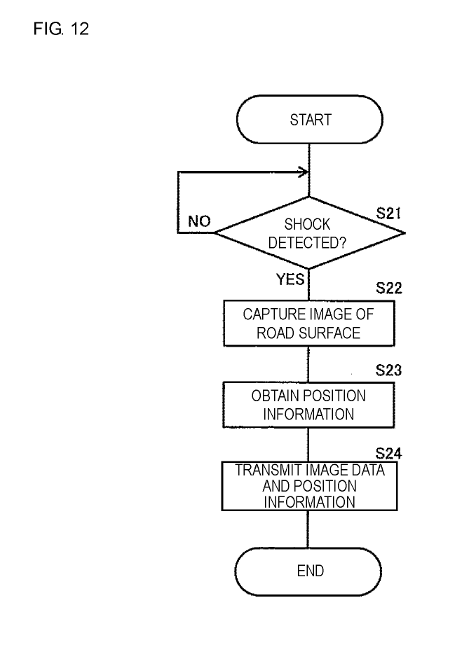

FIG. 12 is a flowchart illustrating the operation of the smart camera 3A according to the second embodiment. Each process of the flowchart illustrated in FIG. 12 is executed by the controller 35 of the smart camera 3A.

In the flowchart in FIG. 12, the controller 35 detects a shock caused by unevenness of the road surface using the shock sensor 32 (S21), and causes the image detector 31 to capture an image of the road surface when the shock is detected (S22), as in steps S1 and S2 in FIG. 7 in the first embodiment. Next, the controller 35 obtains position information from the GPS positioning unit 36 (S23). Accordingly, position information indicating a position when an image of unevenness of the road surface is captured by the image detector 31 can be accurately obtained.

Next, the controller 35 transmits road surface information including the image data, captured by the image detector 31, and the position information, obtained from the GPS positioning unit 36, to the server device 10 via the communication unit 33A and the network 5 (S24), and the process ends.

According to the above process, road surface information can be uploaded to the server device 10 without necessarily using the mobile terminal 4.

As has been described above, the smart camera 3A according to the present embodiment further includes the GPS positioning unit 36, which obtains position information indicating the position of the vehicle 2. The controller 35 of the smart camera 3A obtains, on the basis of a detection result obtained by the shock sensor 32, position information indicating the position of the vehicle 2 when a shock on the vehicle 2 has been detected from the GPS positioning unit 36.

According to the above smart camera 3A, position information when a shock on the vehicle 2 has been detected is obtained from the GPS positioning unit 36, thereby accurately obtaining position information of the unevenness 61 of the road surface 6.

In the above-described embodiment, the smart camera 3A including the GPS positioning unit 36 directly uploads road surface information to the server device 10. Alternatively, for example, the smart camera 3A may obtain position information from the GPS positioning unit 36 at the time an image is captured, and may upload road surface information via the mobile terminal 4 (see FIG. 1) to the server device 10.

### Third Embodiment

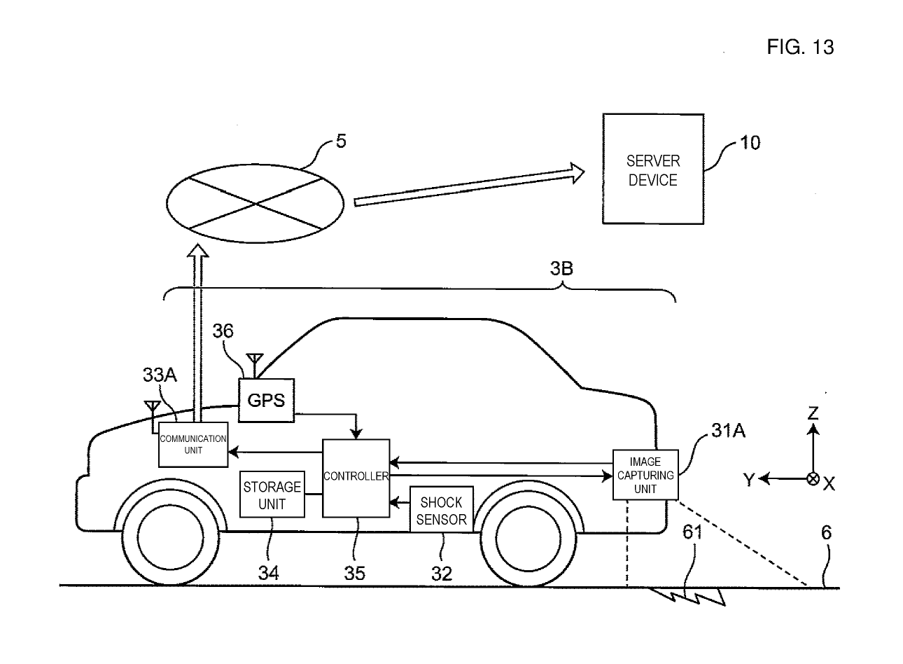

Although the smart cameras 3 and 3A, which are mounted on the vehicle afterwards, are used in the first and second embodiments, a built-in camera provided in advance in a vehicle may be used instead of the smart cameras 3 and 3A. Hereinafter, a modification of this system will be described with reference to FIG. 13.

FIG. 13 is a diagram illustrating the configuration of a road surface information system according to a third embodiment. The road surface information system according to the present embodiment includes a detection device 3B instead of the smart camera 3A according to the second embodiment (see FIGS. 10 and 11). The detection device 3B is a device in which the same (or similar) configuration as that of the smart camera 3A according to the second embodiment is incorporated in the interior of a vehicle 2A, as illustrated in FIG. 13. For example, the image detector 31 of the detection device 3B is built-in as a rear camera in the vehicle 2A. In addition, the controller 35 is mounted as an ECU of the vehicle 2A.

In the detection device 3B, for example, the controller 35 executes each process illustrated in the flowchart in FIG. 12. Accordingly, the detection device 3B, which is incorporated in the interior of the vehicle 2A, can upload road surface information to the server device 10.

Even with the above configuration, the same (or similar) advantageous effects as those of the first and second embodiments can be achieved.

### Other Embodiments

In the above-described embodiments, a shock sensor has been described as an example of a detection unit in a detection device. The detection unit in the detection device is not limited to a shock sensor, and may include, for example, various acceleration sensors such as an electrostatic capacitance sensor and a piezoresistive sensor, or may include a gyro-sensor. Using a gyro-sensor enables detection of a shock on the vehicle 2 on the basis of a change in angular velocity (on, for example, the YZ plane or the ZX plane).

In addition, in the above-described embodiments, a shock in the Z-direction caused by unevenness of the road surface is detected on the basis of a detection result obtained by the shock sensor. A target to be detected by the detection unit is not limited to unevenness of the road surface, and may be, for example, a shock caused by freezing of or pool on the road surface. For example, a shock caused by freezing or the like of the road surface may be detected on the basis of a change in acceleration in the width direction X of the vehicle 2 (see FIG. 1) or a change in angular velocity on the XY plane, and an image of the frozen portion of the road surface on which the vehicle 2 has passed may be captured. In addition, road surface information may be information regarding the state of the road surface in accordance with weather, such as freezing.

In addition, in the above-described embodiments, the GPS positioning units 43 and 36 have been described as examples of a position information obtaining unit. The position information obtaining unit may include, in addition to or instead of a GPS positioning unit, for example, a positioning module based on the quasi-zenith satellite system. Using a positioning module based on the quasi-zenith satellite system enables acquisition of accurate position information.

In addition, in the above-described embodiments, an example in which the vehicle 2, which is an example of a moving object where the detection device is mounted, is a passenger car has been described. A moving object (vehicle) where the detection device is mounted is not limited to a passenger car, and may be, for example, a commercial car such as a bus, a taxi, or a truck, may be various automobiles including motorcycles, or may be bicycles or railway cars.

1. A detection device mounted on a moving object that moves on a road surface, comprising:
a shock sensor configured to detect a shock on the moving object;
an image detector configured to capture an image of the road surface; and
a controller configured to control an operation of the image detector based on a detection of a shock by the shock sensor such that the controller causes the image detector to capture an image of a portion of the road surface that caused the detected shock.

2. The detection device according to claim 1, further comprising:
a positioning system configured to obtain position information indicating a position of the moving object,
wherein the controller is further configured to obtain the position information from the positioning system based on the detection of the shock by the shock sensor such that the obtained position information indicates a position of the image captured as a result of the detected shock.

3. The detection device according to claim 1, further comprising:
a transmitter configured to transmit the image captured by the image detector to an external device.

4. The selection device according to claim 1, wherein:
the shock sensor comprises an acceleration sensor or a gyro-sensor.

5. The detection device according to claim 1, wherein:
the image detector comprises a fisheye camera.

6. A road surface information system comprising:
the detection device according to claim 1; and
a server configured to manage the image captured by the image detector and the obtained position information indicating the position of the captured image, the server associating the captured image and the obtained position information with each other.

7. The road surface information system according to claim 6, further comprising:
a transmitter configured to transmit the captured image with the obtained position information to the server.

8. The detection device according to claim 1, wherein the moving object is a vehicle.
